(19) United States
(12) Patent Application Publication
(10) Pub. No.: US 2020/0123744 A1
(43) Pub. Date: Apr. 23, 2020

(54) METHOD FOR AN EXTRACTION UNIT AND ASSOCIATED EXTRACTION UNIT

(71) Applicant: Franke Technology and Trademark Ltd, Hergiswil (CH)

(72) Inventors: Manuel KEEL, Wildegg (CH); Marco ERNI, Buttwil (CH)

(73) Assignee: Franke Technology and Trademark Ltd, Hergiswil (CH)

(21) Appl. No.: 16/659,672

(22) Filed: Oct. 22, 2019

(30) Foreign Application Priority Data
Oct. 22, 2018 (DE) 102018126214.0

(51) Int. Cl. E03C 1/04; E03C 1/05; F16K 3/34; H04L 12/28; G10L 15/22

(52) U.S. Cl. CPC E03C 1/0412; E03C 1/057; F16K 3/34; G10L 2015/223; H04L 12/2827; G10L 15/22; H04L 12/282

(57) ABSTRACT

A method for adapting a control menu of an extraction unit (10) for drinking water (11) to a network (12), having the steps of: connecting a new device (14), wherein the extraction unit is connected to one or more devices using communication technology to form a network (12), in particular in the form of a bus system; transmitting a physical address of the new device (14) into the network (12) to the extraction unit (10); creating a new device register with the physical address of the new device (14) in the controller of the extraction unit (10); and automatically adapting the control menu of the extraction unit (10) to the new device register, with the result that the new device (14) can be controlled via the extraction unit (10). An extraction unit for carrying out such method is also provided.

### INCORPORATION BY REFERENCE

The following documents are incorporated herein by reference as if fully set forth: German Patent Application No. DE102018126214.0, filed Oct. 22, 2018.

### BACKGROUND

The invention relates to a method for adapting a control menu of a controller of an extraction unit for drinking water having a command input element for selecting a control menu item of the control menu, in particular a rotary pushbutton. The invention also relates to an extraction unit for drinking water comprising a controller with a control menu having control menu items, a command input element for selecting a control menu item, in particular a rotary pushbutton, wherein the extraction unit can be connected to other functional units.

Extraction units for drinking water which are connected to water functional units both electrically and in a fluid-conducting manner are known. In this case, a plurality of water functional units with different functions can be connected to an extraction unit. In the case of known extraction units, a controller which is installed under the work surface is provided for this purpose, to which controller the individual water functional units are connected in order to control the latter and to connect the water lines coming from the functional units to the actual extraction unit. So that different water functional units can be accordingly controlled by the extraction unit, their controller must be programmed in a complicated manner. Extraction units typically have only very simple command input elements, which further complicates operation and programming of the extraction unit. Alternatively, a hardware controller adapted according to the number and function of the water functional units can be provided. The hardware controller must be specifically adapted to the type and number of water functional units, which results in high costs of the controller.

WO 2016/131500 A1 discloses, as an extraction unit, a water tap having a simple rotary pushbutton. The water tap is connected to a separate water extraction controller and comprises control valves which are connected to the water extraction controller and are intended to control water flows from the water tap. A cold water source or a mixed water source and at least one additional water source, which may be a filtered water source, a cooling water source, a carbonated water source and a boiling water source, are connected to the water tap.

Since only a rotary pushbutton having a simple display in the form of a multi-color light ring is available on the water tap as a command input element, the different water sources must be controlled by a sequence of command inputs, that is to say rotating and pushing the rotary pushbutton, in order to extract accordingly treated water. For this purpose, individual menu items are controlled in a control menu of the rotary pushbutton. The control menu must therefore be accordingly adapted to the type and number of connected water functional units, which requires complicated programming and configuration during installation. Furthermore, only water sources and associated control valves can be connected to the extraction unit. Therefore, integration of the extraction unit in a network comprising a multiplicity of devices which partially do not have a water-dispensing function is not provided. Therefore, the extraction unit taught in said document is not networkable and therefore also cannot be easily connected to a home automation system.

Even though the known extraction units for drinking water perform their function, the field of extraction units for drinking water still offers room for improvements.

### SUMMARY

The invention is based on the object of providing a method for an extraction unit for drinking water and such an extraction unit which can be set up with very little effort and can preferably be integrated in a home automation network.

This object is achieved by a method for an extraction unit for drinking water having one or more features of the disclosure. The object is also achieved by the extraction unit for drinking water having one or more features of the disclosure. Advantageous configurations and developments of the invention emerge from the description and claims that follow.

It should be pointed out that the features and measures cited individually in the following description can be combined with one another in any desired, technically useful manner and show further configurations of the invention. The description additionally characterizes and specifies the invention, in particular in conjunction with the figures.

The method according to the invention for automatically adapting a control menu with control menu items of a controller of an extraction unit for drinking water having a command input element, wherein the extraction unit is connected to one or more devices used as functional units using communication technology to form a network, carries out the following steps of:

connecting a new device to the network,

transmitting a physical address of the new device to the extraction unit via the network,

creating a new device register with the physical address of the new device in the controller of the extraction unit, and

automatically adapting the control menu of the extraction unit to the new device register, with the result that the new device can be controlled via the extraction unit.

Due to the automatic adaptation of the control menu items in the control menu, it is possible to use a simple command input element (operating element) which has only a few adjustment possibilities. Automatic adaptation supports the use of simple command input elements such as rotary pushbuttons since there is no need for complex manual programming of the controller via the command input element.

The extraction unit may be a water tap which interacts with a valve for opening and closing the drinking water outlet. A command input element for the control menu is also provided on the extraction unit and can be used by a user to navigate through the control menu and to select control menu items for various functions of the extraction unit or of functional units connected to the latter. The command input element is, in particular, a rotary pushbutton or a push rotary selection switch. The control menu is carried out by the hardware components of the controller of the extraction unit and constitutes an interface between a user and the extraction unit. The controller may be provided on a printed circuit board in the extraction unit. The printed circuit board can preferably be installed in the command input element and can directly receive commands from the user. Alternatively, the controller may be arranged outside the extraction unit and may communicate with the extraction unit via a cable connection or a radio connection.

The new device can be connected to the network in a wireless manner or by a wired connection. In particular, the controller of the extraction unit may be equipped with an internal radio antenna for a wireless connection or may be connected to an external antenna. For example, a Bluetooth, a Zigbee, a Wi-Fi, a 2.4 GHz and/or a 5 GHz radio connection, a DECT, an EEBUS or an IEEE connection is/are possible. Alternatively or additionally, the connection can be implemented via Ethernet using LAN cabling. In one preferred embodiment, the devices and the extraction unit are connected to one another via a serial bus system or a field bus, in particular a CAN bus (Controller Area Network). The network may be a local area network and a network connected to the Internet. The network may also be in the form of a cloud with a multiplicity of devices. As a result of the multiplicity of possible ways of establishing a connection between the network and the extraction unit, the extraction unit can be positioned at any desired location and can nevertheless be connected to the network with high transmission quality.

After the new device has been connected to the network, it transmits a physical address into the network via a data connection. The physical address may be a hardware address of the network adapter of a respective device, for instance a MAC address, a serial number of the device, a model number of the device, an Ethernet ID or another device-fixed identifier which uniquely assigns, in particular, properties of the device to an individual device in the network. The physical address is transmitted to the extraction unit via the network. The devices participating in the network are stored in the device register, preferably on the individual devices, with the result that each device knows the other network participants and, in particular, their properties. This produces a transparent and easily manageable network structure.

The controller of the extraction unit automatically detects the presence of a new physical address representing the new device and reads the new physical address and independently creates, on the basis of the new physical address, a new device register of all devices participating in the network, including the new device. This device register is preferably locally stored on the controller of the extraction unit. Automation makes it possible to set up the extraction unit in a user-friendly manner.

The controller automatically creates a new control menu for the extraction unit on the basis of the new device register. For this purpose, the controller reads the new device register and changes an existing control menu according to the new property of the new device. The new control menu comprises at least one new control menu item for the new device and its function, with the result that it can be taken into account by the extraction unit. For example, the new device may expand or restrict functions of the extraction unit. Furthermore, the new device can be controlled by the command input element of the extraction unit.

As a result of the solution provided according to the invention, the control menu is automatically adapted to the network participants. As a result, new devices can be very easily connected according to user requirements without the need for specialist knowledge of the devices or the network. A user can therefore exploit the variety of functions of modern networkable devices and, at the same time, can set up the corresponding network for this purpose in a manner which saves costs and time. Such an automatic extraction unit is of the greatest benefit for setting up a home automation system, in particular, since it must only be coupled to the network in order to adapt it completely to the existing devices. A simple command input element which has only a few adjustment possibilities can preferably be used.

In principle, two situations, according to which a new device is added, are conceivable. In the first situation, devices are already present and operating in the network and a new device is then added as a later time, for example by virtue of the new device being connected to the network or by virtue of the energy supply for the device being activated at this later time. In the second situation, all devices on the bus are switched on at the same time. According to one advantageous configuration of the invention, provision may be made for the first situation to be converted into the second situation by carrying out a reset in all devices as soon as a new device on the bus is detected.

Within the scope of the present invention, provision may also be made for a device, after transmitting its network address, to transmit a feature list, that is to say a list containing the functions supported by this device. Devices which receive this preferably store the feature list in the device table.

It is advantageously possible to automatically create a control menu item in the control menu which represents the new device in the controller of the extraction unit. In this case, a control menu item can be set up for a function of the new device in the control menu, with the result that the control menu item can be selected by the command input element. As a result of the control menu item being selected, the new device can be controlled and can perform its function. For example, the function may involve supplying drinking water to the extraction unit in a particular treated form, with the result that a user can select and extract particular drinking water on the basis of the control menu item. Furthermore, the new device can automatically delete or block a control menu item on the basis of its function. On account of this advantageous automatic creation, deletion or blocking of a new control menu item, a user can equip the network with new devices in a time-saving manner without expert knowledge.

A special development of the invention may provide automatic blocking of the extraction unit by the control menu if the controller of the extraction unit detects a conflict between a first device and a second device in the network. Such a conflict may result from functions which act in an opposite manner. For example, devices which provide boiling and carbonated water may be in conflict since they should not simultaneously provide the extraction unit with water. Furthermore, devices may also be in an energy conflict with respect to one another. If two devices have a high electrical power, the two devices cannot be operated at the same time under certain circumstances. These devices can be prioritized by an energy measuring device and can be supplied with electrical energy in succession. In particular, the energy measuring device can be entered here in the device register as a new device and can therefore influence the control menu. The energy measuring device can ensure that a first device which does not provide the extraction unit with any water, for example, is supplied with energy, with the result that a second device which provides the extraction unit with treated water is blocked. Accordingly, the control menu of the extraction unit assumes a blocked state and does not allow the second device to be controlled. An energy conflict between two devices may be present if too little energy is available, which may occur in alternative forms of energy such as solar installations or wind power installations. Intelligent and environmentally friendly energy management can be implemented as a result. Another reason for an energy conflict is an electrical home installation which has not been adequately dimensioned, with the result that current can be conducted to the devices only to a limited extent on account of small copper wire cross sections or protection in order to avoid heating and possibly cable fires. As a result, the extraction unit according to the invention can also increase the safety of an electrical installation.

In another advantageous embodiment, a control menu item in the control menu can be deleted if a device is removed from the network. After the device has been removed from the network, the absence of this device is automatically detected by the extraction unit and the device register of the extraction unit is therefore newly drafted. The control menu can be newly compiled according to the new device register and a control menu item which represented the previously removed device will be deleted from the new control menu. For example, in another additional embodiment, a device which has been removed can be detected by transmitting the physical address or other signs of life in the case of connected devices at regular intervals of time or immediately after the voltage supply has been switched on. The device register can therefore be confirmed during each transmission provided that the combination of devices participating in the network has not changed. As soon as a device is removed from the network, it cannot transmit a physical address or another sign of life into the network and the number of physical addresses in the network therefore does not correspond to the device register. This may be used by a device, in particular the extraction unit, as an opportunity to create a new device register and therefore also a new control menu. As a result of these advantageous embodiments, networks can in turn be compiled in a simple automated manner according to the user's requirements without the user having to obtain expensive and time-consuming expert assistance.

If a new physical address of the new device is now received in the controller of the extraction unit, the old device register can be deleted and can be replaced with the new register, which saves computing power, in particular, in the controller of the extraction unit. Alternatively, the old device register can be overwritten with the new device register, which can likewise save computing power. Another alternative comprises modifying the old device register to form a new device register by creating a new address line in the device register for a new device and/or deleting or deactivating an old address line for a device which has been removed. This makes it possible to generate a log-style device register which can be used for subsequent fault analysis, for example.

The device register can be sorted on the basis of properties of the physical addresses of the devices and an indication of the respective physical address with a network identification. In this case, a sequence of the devices is created in the device register, which sequence is based on the serial number of the devices, the alphabet, functions, numbers, the power of the devices, the date on which the devices were connected to the network and/or the period for which the devices have been connected to the network. The network identification is an additional identification of the physical address in the device register, on the basis of which the position of the device register can be determined. This makes it possible to create a device register which can be read quickly.

In order to provide a correct device register, it is checked, in another development of the invention, whether the network identification is uniquely assigned to a physical address. If the network identification is incorrectly assigned to a physical address, the physical addresses can be repeatedly transmitted. In this case, the correctness of the device register is checked, in particular, in the extraction unit. Furthermore, the correctness of the device register can be checked in each device in the network. The check can be carried out by each device per se. An incorrect assignment may result in two physical addresses which each belong to different devices being identified with the same network identification.

In one advantageous configuration of the method, a function of the device is identified on the basis of the device register. Accordingly, the identified function is created as a control menu item. The physical address may contain information relating to the type and function of the respective device. In accordance with the function, it is possible to create a control menu item which is in the context of the function. The device may preferably be a water functional unit which is used to treat drinking water for the extraction unit. If, for example, three water functional units for providing drinking water with a high, a medium and a low temperature are provided, the control menu items can be arranged in the order of the temperature gradient between the water functional units or in the order of the water temperatures provided by the water functional units on the basis of the respective function of the water functional units. A control menu item for the high temperature can thus be used before the control menu item for the medium temperature or vice versa, whereas the control menu item for the medium temperature can be positioned between the control menu item for the low temperature and the control menu item for the high temperature. Thematic groups of functions may also be created within the control menu, with the result that all functions which filtered, carbonated, chilled and/or heated can be used in succession in respective groups. This provides an intuitively usable control menu which has a particularly user-friendly and simple structure.

An extraction unit which indicates an overview of the state of the extraction unit to the user by displaying a control menu item for a device and/or a function and/or blocking of the extraction unit on a display is particularly preferred. The display can use a different symbol for each control menu item. The symbol may comprise a color, a sound and/or an image.

Different display elements such as LEDs in the display can be activated for different control menu items. This makes it possible to reflect functions such as the temperature, the carbon dioxide content and/or the degree of filtering. For example, a high temperature of the drinking water may cause the display to emit red light. A low temperature of the drinking water may result in the display emitting blue light. A medium temperature of the drinking water may be signaled by the display emitting orange light. Furthermore, carbonated drinking water may be indicated by the display emitting white light. Filtered drinking water may be indicated by the display emitting green light. Blocking of the extraction unit may be represented by a red-and-white interrupted display. Furthermore, the display for particular states of the extraction unit or functions of the devices may emit flashing light or may emit light continuously. The display may be effected in an annular manner, a punctiform manner, a linear manner, a flat manner, in the form of a display and/or by projection onto a surface. For example, an annular display may be arranged in the region of the command input element. The annular display may be positioned between the command input element and the extraction unit. It is also possible to equip a region or an area of the command input element with the display. Alternatively, a projecting light source may be arranged on the extraction unit, in particular in an outflow and/or in the command input element.

One development of the optical display is a display or a projection which represents images in the context of the state of the extraction unit or of the selected function in the control menu. For example, a drop of water can be displayed while extracting drinking water. If the extraction unit is set to the menu item for cold drinking water, a snowflake or a snowman can be displayed. If hot drinking water is extracted, a thermometer or another symbol for heat can be displayed. Alternatively, words such as “hot”, “cold”, “warm”, “sparkling”, “filtered” or “blocked”, which provide a clear indication of the function or the state of the extraction unit, can also be projected or displayed on a display.

Furthermore, a state of the extraction unit or a function of a device can be communicated to the user via an acoustic output means. For example, words or melodies can be output by the command input element and/or the extraction unit and/or an external loudspeaker. For example, the word “hot” or “red” can be output for a high temperature. Furthermore, a warning such as “caution” can also be output. “Cold” or “blue” can be output for a low temperature. “Filtered”, for example, can be output for filtered drinking water and “sparkling”, for example, can be output for carbonated drinking water.

The displays mentioned can likewise be used to display states of the extraction unit when reading and writing to the device registers. Such a state can be displayed, for example, by flashing or a further color, for example violet.

The different types of display all have the feature in common that a user is immediately informed of the state of the extraction unit and the function of the selected device in a simple and clear manner. This ensures a high degree of safety and efficiency for using the extraction unit.

The controller can mutually coordinate a plurality of devices which are connected to the extraction unit and, according to the functions stored behind the control menu items, treat drinking water which can be extracted from the extraction unit with regard to the temperature, carbon dioxide content and/or degree of filtering. For example, two water functional units for hot water of the same temperature of approximately 110° C., in particular, can be connected to the extraction unit in order to increase the capacity for hot water. Water can be alternately extracted from these two water functional units, in which case only one control menu item is created for the function of “hot water”. Furthermore, two hot water assemblies with different high temperatures of preferably 110° C. and 85° C. can be connected to the extraction unit. In this case, two separate control menu items for the respective high temperatures are created in the control menu. Alternatively, water functional units for hot and cold drinking water can be connected in parallel or in series with one another and can be coordinated with one another. If, for example, carbonated water is extracted from a water functional unit via the extraction unit, the controller can ensure that the lines are rinsed with normal water, with the result that no carbonated water remains in the lines. In particular, dishwashers and water functional units for hot water can be coordinated with one another in order to avoid an energy conflict with one another. This coordination can be carried out via an energy switch or an energy measuring device. The mutual coordination of the connected devices can provide an optimum quality of the drinking water under conditions which are favorable in technical terms and in terms of energy.

The energy measuring device measures the power consumption of an external load, for example a dishwasher. If the power consumption is high, functions on a connected water functional unit can be blocked. The measuring device and the behavior of the device connected to the latter therefore implement the function of an energy switch.

The command input element may be in the form of a rotary knob, a pushbutton, a rotary pushbutton, a touchscreen, a lever, a rocker switch and/or a button. In this case, the display may be arranged in the region of the command input element in such a manner that it is visible from any position.

One preferred embodiment of the command input element comprises starting dispensing of drinking water from the extraction unit by a voice command to a preferably intelligent voice assistant. For example, the command “water” can be directed to the voice assistant. Furthermore, the command may be supplemented with a property such as “hot”, “cold”, “sparkling” and/or “filtered”. The intelligent voice assistant may be installed in the extraction unit or may be present outside the extraction unit and connected to the network in this case.

Dispensing of drinking water can be advantageously started by touching the extraction unit, wherein a capacitive sensor detects the touch. A simple touch can be used to start an extraction unit if it is preferably connected only to one or more water functional units which do not provide hot water. This ensures increased safety for the user against scalding his hands. Alternatively or additionally, the dispensing of the water can be started by actuating an external sensor. The external sensor may be a foot switch, for instance a light barrier which can be actuated with the foot. A safety circuit could therefore be formed by simultaneously actuating the command input element on the extraction unit and the external foot switch. In particular, a control menu item can be selected using the foot switch.

The solution provided according to the invention can be used in a particularly advantageous manner in a network for home automation. For this purpose, the extraction unit is part of a home automation system and can communicate with a central controller of the home automation system. The central controller can coordinate the various devices in the network with one another according to a connectivity principle and can functionally bring them in line with the extraction unit. A user can monitor and control the devices via the network using his mobile terminal such as a smartphone. An app for the mobile terminal may be provided for this purpose. A user could therefore monitor the state of the extraction unit and could possibly select a control menu item and start the extraction unit. This makes it possible to remotely control the extraction unit.

### BRIEF DESCRIPTION OF THE DRAWINGS

Further advantageous configurations of the invention are disclosed in the following description of the figures, in which:

FIG. 1 shows a schematic illustration of a network having various devices, wherein one of the devices is an extraction unit which is connected to water functional units in a fluid-conducting manner,

FIGS. 2A and 2B show an extraction unit having a command input element which has an annular display,

FIGS. 3A and 3B respectively show an extraction unit which is connected to one water functional unit and to two water functional units which are connected in parallel with one another,

FIGS. 3C and 3D respectively show enlarged details of the command input element and the display of the extraction units shown in FIGS. 3A and 3B,

FIG. 4 shows an extraction unit which is connected to a water functional unit which obtains its energy, together with a dishwasher, via an energy measuring device, wherein the display on the command input element displays a blockage,

FIG. 4A shows an enlarged detail of the command input element and the display of the extraction unit shown in FIG. 4,

FIG. 5 shows an extraction unit which has two water functional units connected in series,

FIG. 5A shows an enlarged detail of the command input element and the display of the extraction unit shown in FIG. 5,

FIG. 6 shows an extraction unit which is started by touching a capacitive sensor and/or a foot switch,

FIG. 7 shows an extraction unit which is connected to a central controller in the network and is remotely controlled via a mobile terminal,

FIG. 8 shows a schematic illustration of the creation of a new control menu from a new device register, and

FIGS. 9A to 9C show a flowchart of the creation of a new device register after a new device has been connected.

### DETAILED DESCRIPTION

In the different figures, identical parts are always provided with the same reference signs, which is why these parts are generally also described only once.

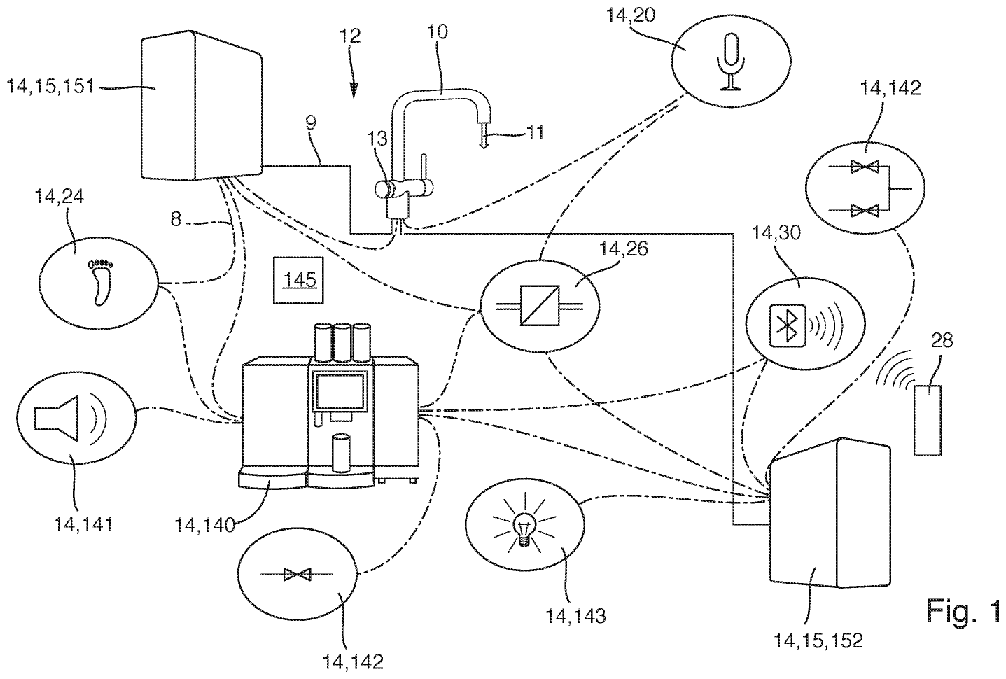

FIG. 1 shows a network 12 comprising an extraction unit 10 for drinking water 11. The extraction unit 10 is connected to further devices 14 via data connections 8. The further devices 14 are connected to a controller 13 of the extraction unit 10 via the data connection 8. As a result of the controller 13, the extraction unit 10 is set up for the devices 14 in the network 12, with the result that the functions of the extraction unit 10 are adapted according to the functions F of the devices 14. The devices 14 participating in the network 12 can be coordinated and selected via the controller 13 of the extraction unit 10. The different devices 14 automatically register with the controller 13, with the result that a user need not take any measures whatsoever in order to synchronize the extraction unit 10 with the network 12 and the participating devices 14 in the latter.

In the exemplary embodiment, the data connection is effected via a CAN bus. The CAN bus operates according to the “multi-master principle”, that is to say it connects a plurality of equal control devices. The CAN network is preferably constructed as a line structure. Spur lines are permissible to a limited extent. A star-shaped bus is also possible. Communication is effected using messages according to a predefined CAN protocol. The messages have a standardized structure in the form of message frames.

Coffee machines 140, loudspeakers 141, intelligent valves 142 for controlling fluid flows inside a fluid-conducting connection 9, lighting 143, dishwashers 145, external sensors 24 for actuating the extraction unit 10, intelligent voice assistants 20, central controllers 26 for a home automation system, mobile terminals 28 such as smart phones and/or smart pads, radio connections 30 such as a Bluetooth and/or Wi-Fi antenna and/or water functional units 15 are possible as devices 14. The respective devices 14 may be included in the network 12 in a single embodiment or in multiple embodiments. In particular, the water functional units 15 can provide different types of drinking water 11, for example, with the result that at least a first water functional unit 151 and a second water functional unit 152 can be provided for filtered, carbonated, cold, warm and/or hot water. Yet further water functional units 15 can also be inserted into the network 12. The water functional units 15 are connected to the extraction unit 10 via the fluid-conducting connection (water lines) 9.

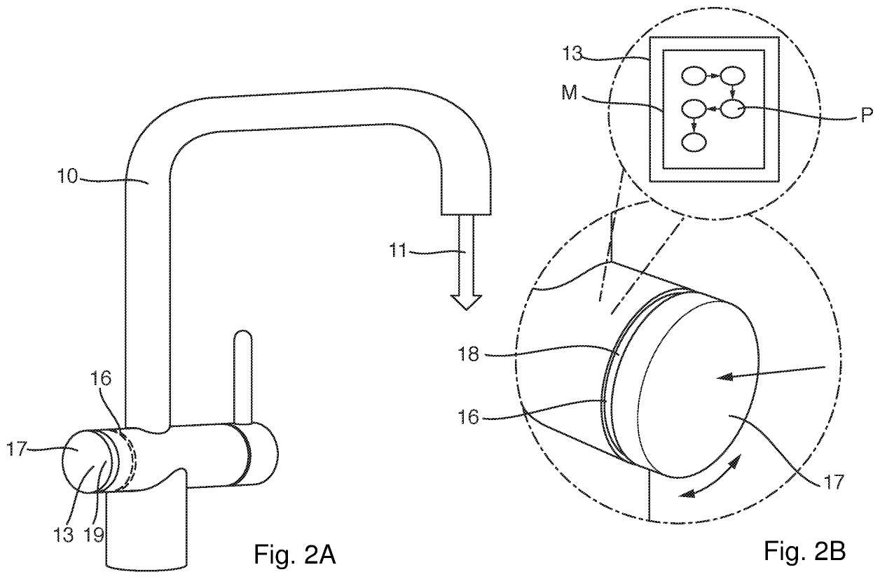

FIG. 2A depicts an extraction unit 10 which has a mixer lever. The extraction unit 10 also comprises a command input element 17 which is in the form of a rotary pushbutton 19. The rotary pushbutton 19 can be used to control the extraction unit 10, in which case the button 19 can be rotated and pushed in an axial direction. An annular display 16 which runs around a section of the extraction unit 10 in an annular manner is arranged between the command input element 17 and the extraction unit 10. Alternative forms for the display 16 are also conceivable, in which case a flat, line-like, star-like, circular, square or rectangular shape of the display 16 is possible.

FIG. 2B illustrates an enlarged view of the command input element 17. The command input element 17 can be used by a user of the extraction unit 10 to navigate through a control menu M of the controller 13 and to select different functions and for the extraction unit 10 devices 14 connected to the network 12. In this case, a user can switch back and forth between control menu items P by rotating the rotary pushbutton 19 and can confirm a control menu item P by pushing the rotary pushbutton 19. The rotation is symbolized in FIG. 2B by a curved double-headed arrow and the pushing is symbolized by a straight arrow. The control menu M is a program which is run on a hardware printed circuit board of the controller 13, wherein the program of the control menu M is operated by the command input element 17. The hardware printed circuit board can be positioned in the extraction unit 10 or outside the latter. In particular, the hardware printed circuit board can be arranged in the command input element. The control menu items P are automatically programmed into the control menu M if a device 14 is connected in the network 12. Control menu items P are likewise automatically deleted from the control menu M if devices 14 are removed from the network 12. The control menu M with the control menu items P and schematic navigation through the control menu M is illustrated in a circle in FIG. 2B.

The display 16 is a color display behind which display elements 18 are located. The display elements 18 may be color LEDs which emit red, yellow, orange, blue, white, violet and/or green light. Yet further colors may also be implemented by the LEDs. Furthermore, the display elements 18 may flash or emit continuous light. The display 16 may also display a continuous change between the colors. In addition, color patterns such as red-and-white can also be displayed on the display 16.

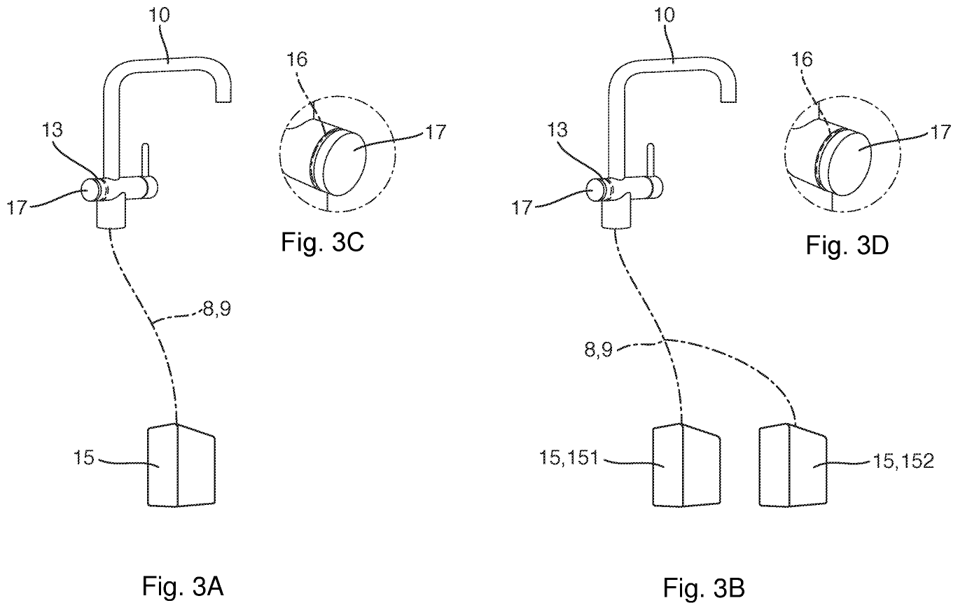

FIG. 3A shows a simple connection comprising an extraction unit 10 and a water functional unit 15. The water functional unit 15 is connected to the extraction unit 10 by a data connection 8 and a fluid-conducting connection 9. The water functional unit 15 may be a hot water or boiling water assembly, for example. The water with the high temperature can be extracted from the extraction unit 10 by virtue of the water functional unit 15 being controlled by the controller 13. For this purpose, a control menu item P in the control menu M is selected and confirmed via the command input element 17, shown in detail in FIG. 3C. The water functional unit 15 is finally started as a result of the confirmation. Alternatively, the water functional unit 15 may be a cold water, filtered water and/or carbonated water assembly. These assemblies are represented and selected by separate control menu items P in the control menu M.

As shown in FIG. 3B, a further embodiment involves the combination of two water functional units 151, 152 which are connected in parallel with one another. For example, a first water functional unit 151 for cold water and a second water functional unit 152 for hot water can be provided. The two water functional units 151, 152 can be represented separately by control menu items P in the control menu M and can be selected by the command input element 17, shown in detail in FIG. 3D. Alternatively, a combination with a water functional unit 15 for filtered water and/or carbonated water can be effected.

The display 16, shown in FIGS. 3C and 3D, emits red light when a control menu item P representing boiling water is selected, whereas the display 16 emits blue light in the case of a control menu item P for selecting cold water. The display can emit green light for filtered water when the corresponding control menu item P is selected and the display 16 can emit white light for carbonated water.

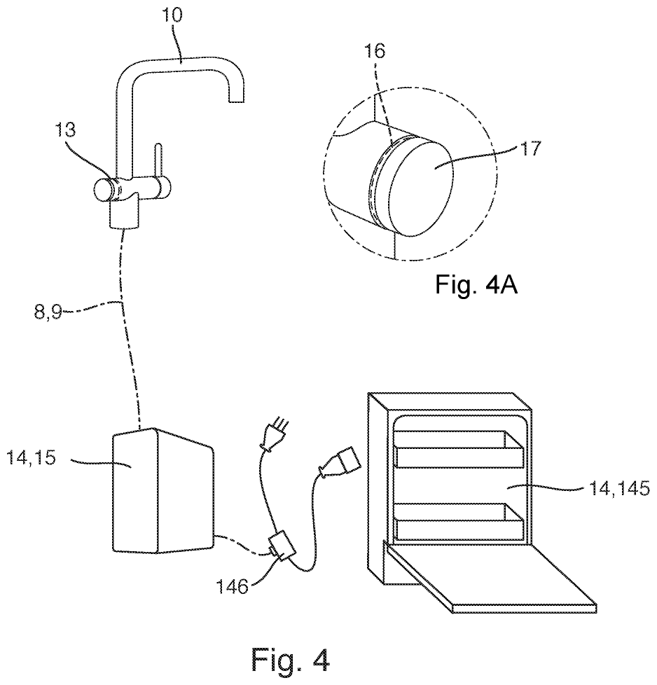

As disclosed in FIG. 4, it is possible to connect the extraction unit 10 to a water functional unit 15, while a dishwasher 145 is connected in the network 12. Since both the water functional unit 15 and the dishwasher 145 have a high power consumption, an energy measuring device 146 can be connected between the two devices 14. The energy measuring device 146 can prevent the water functional unit 15 from being selected when the dishwasher 145 is switched on. The control menu item P for the water functional unit 15 is blocked, in which case the blocking is displayed by a red-and-white dashed pattern on the display 16. During blocking, actuation of the command input element 17, shown in detail in FIG. 4A, is not possible and does not result in control of the water functional unit 15. Such a conflict between two devices 14 can occur whenever two devices 14 having high power consumptions are intended to be operated at the same time. Instead of the dishwasher 145, a washing machine or an air-conditioning system may also be possible.

The energy measuring device 146 measures the power consumption of an external load, for example a dishwasher. If the power consumption is high, functions on the water functional unit 15 can be blocked. The measuring device 146 and the behavior of the device connected to the latter therefore implement the function of an energy switch. The element 146 itself need not switch or divert any energy for this purpose, even though the latter is not excluded and is likewise concomitantly included within the scope of the present invention.

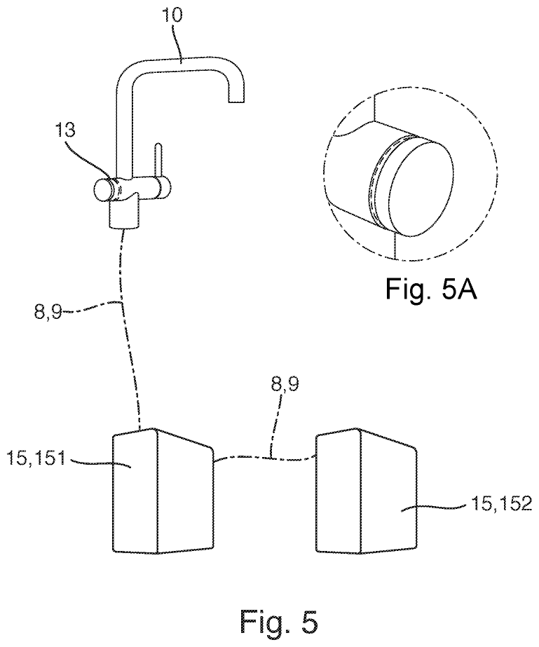

FIGS. 5 and 5A show a further configuration of two water functional units 151, 152. The two water functional units 151, 152 are connected in series. They can be used as water sources for boiling water. For example, both water functional units 151, 152 can hold water of the same temperature. The temperature of the pressurized boiling water inside the boiling water assembly can preferably be approximately 110° C. This increases the capacity for such temperature-controlled water. The water can be alternately obtained from the water functional units 151, 152. Alternatively, two different temperatures may be held in the water functional units 151, 152 and one of the two functional units can be activated depending on which control menu item P is selected. For example, one water functional unit 151 can hold water at 110° C. and the other water functional unit 152 can hold water at 85° C.

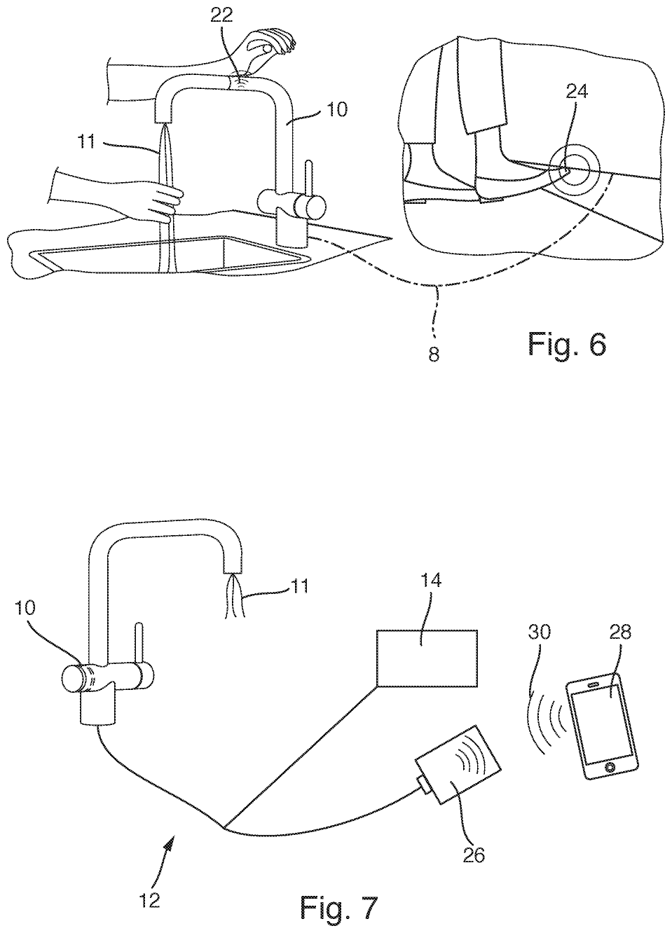

FIG. 6 shows a capacitive sensor 22 which is arranged in the extraction unit 10 and can be actuated, via the body of the extraction unit 10, by touching the latter with the hand. Furthermore, an additional external sensor 24 can be actuated using the foot of a user. This external sensor 24 is connected to the extraction unit 10 using a data connection 8. The data connection 8 may be a wireless and a wired connection. The external sensor 24 can be connected to the extraction unit 10 via the network 12 or directly. Drinking water 11 is conducted from the extraction unit 10 by simultaneously actuating the external sensor 24 and the capacitive sensor 22. The combination of the capacitive sensor 22 with the external sensor 24 provides increased safety. In particular, a combination of the two sensors 22, 24 can be used with a water functional unit 15 for hot and boiling water.

FIG. 7 comprises an extraction unit 10 which is connected to at least one device 14 and to a central controller 26 of a home automation system via the network 12. The central controller 26 is equipped with a radio antenna, with the result that it can establish a radio connection 30 to a mobile terminal 28. The extraction unit 10 can be controlled and monitored by the mobile terminal 28 which may be a smart phone or a smart pad or another mobile device. For example, an app can be installed on the mobile terminal 28 which can be used to control and monitor the extraction unit 10.

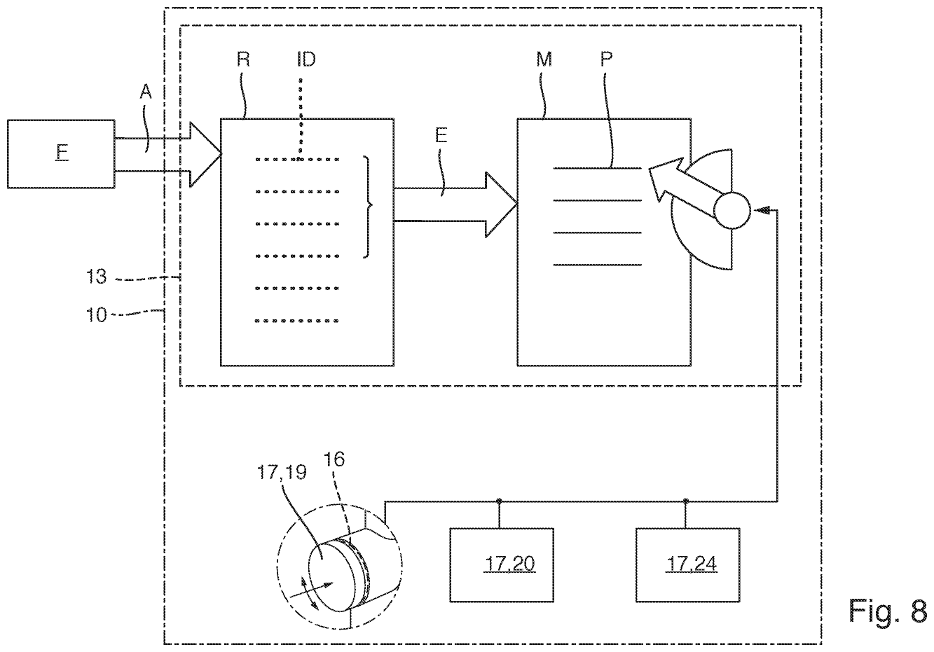

FIG. 8 illustrates the creation E of the control menu M for new functions F. If a new device 14 is connected to the network 12, a new function F is added to the already existing functions in the network. If this new function F relates to the extraction unit 10, this new function F affects the control menu M.

The new device 14 transmits a physical address A to the controller 13 of the extraction unit 10. The physical address A is entered into a newly created device register R in the controller 13. Physical addresses A of devices 14 which do not influence the extraction unit 10 can also be stored in this device register R, in particular. The physical addresses A are sorted in the device register R and are provided with a network identification ID. A part of the network identification ID relating to the extraction unit 10 is then preferably used to compile a new control menu M. In this case, control menu items P are created in the control menu M of the controller 13 in a manner corresponding to the network identifications ID. The control menu items P can be selected using command input elements 17. For example, the rotary pushbutton 19 and/or an intelligent voice assistant 20 and/or an external sensor 24 and/or another command input element 17 described above can be used. In accordance with the control menu items P, the display 16 emits light in a color reflecting the selected function F.

A serial number which is uniquely allocated for each device which can be connected to the network is used as the physical address A in the following example. The serial number is allocated during production in the factory and is permanently programmed into the device. The serial number has the following functions:

Unique number for CAN address assignment (serial number is allocated only once throughout the world),

Firmware compatibility can be determined,

Production date is intended to be discernible,

Checking device and therefore also production location,

Exact hardware version (for example for replacement parts),

Form factor and connections for the end customer (compatibility of accessories).

In the exemplary embodiment, the serial number is 64 bits long and consists of the following parts:

Device family (6 bits): devices which perform a similar function. The meaning of the so-called feature vector (see below) also relates to this number. For example, a water tap, a foot switch and a water tap with a motor are in the same device family since they are all operating devices. It is therefore possible to subsequently introduce a foot switch into the range and to switch the function on and off, for example to use a drinking water extraction unit, the software of which was developed as if there were not yet the foot switch.

Device type (8 bits, begins again with each device family): distinction within the device family, for example water tap, foot switch and water tap with motor have different device types.

Software compatibility (5 bits, begins again with each device family and device type): changes if the software must be adapted on account of hardware changes (for example additional outlet for free running of a valve).

Design version (5 bits, begins again with each device family and device type): changes if the appearance or the connections of the device change(s), for example due to a changed water hose diameter or housing width. This number is needed to choose the correct accessory and sometimes the correct replacement part.

Hardware version (6 bits, begins again with each device family, device type and software compatibility): only hardware changes which do not entail any software adaptation and any functional change, for example another valve or another power transistor.

Checking device (5 bits, begins again with each device family and device type): unique sequence number of the checking device for the corresponding device family and device type. In a factory, a plurality of checking devices may represent the same device family and device type but have different checking device numbers.

Production date according to production year (7 bits), production month (4 bits) and production day (5 bits).

Sequence number (13 bits, begins again with each device family, device type, checking device and day): the sequence number is incremented for each instance of a device, with the result that a unique number is produced with the device family, device type, checking device and the dates.

The compatibility of the firmware can be determined using the device family, device type and software compatibility, and any firmware is approved for a combination of the device family, device type and software compatibility.

The details of the device family, device type, software compatibility, design version and hardware version make it possible both to select the correct accessory and, in the event of a production error, to find the accordingly incorrectly produced parts in the warehouse.

The software of each device contains a table containing 32 possible entries which is referred to as a device register. Each entry has 16 bytes. The table records all devices which are connected in the network. The software routines which are installed on all devices ensure that the table of participants on each device in the network has the same appearance. The table contains the following details:

| Description | Size (bits) | No. of values | Comment |
|---|---|---|---|
| Current CAN ID | Index of the | Depends on the | Current CAN ID = |
| | table | array size | index of the |
| | | | table entry + 10 |
| Device family | 6 | 64 | Device family of |
| | | | the device |
| Meaning of the | 2 | 4 | 0 = serial number, |
| data field | | | 1 = device features, |
| | | | 2 and 3 = reserved |
| Serial number | 64 (plus 40 for | | Device serial |
| | future use) | | number (during |
| | | | CAN start-up) |
| Device features | 104 | 104 × 1 bit | Supported device |
| | | | features, wherein |
| | | | each bit |
| | | | represents one |
| | | | device feature: |
| | | | bit = 0: feature is |
| | | | not supported |
| | | | (default); bit = 1: |
| | | | feature is |
| | | | supported |
| Sign of life time | 16 | 65536 ms = | Time stamp in ms |
| stamp | | 1.1 min | from the last |
| | | | reception of a sign |
| | | | of life (“heartbeat” |
| | | | message) |

The device features, that is to say the functions supported by the relevant device, are defined separately for each device family. Each bit describes a function which can be made available to the network by the corresponding device. Other devices can determine, on the basis of the device type and its feature list, which functions of another device they can use. In this case, the list of functions can be expanded over the course of time, wherein devices with older software can use only functions which were already defined during their programming. However, it is ensured that older devices can use the basic functions of new devices without the need for a software update on the older device.

The following example is intended to be used to describe how the device feature list functions. In this scenario, a drinking water extraction unit and a water functional unit of a first product generation (V1) are involved. The feature list of the water functional unit V1 is as follows:

| | | Supported by water |
|---|---|---|
| Feature no. | Description | functional unit V1 |
| 1 | Can provide filtered | X |
| | water | |
| 2 | Can provide chilled | X |
| | water | |
| 3 | Can provide carbonated | X |
| | water | |
| 4 | Can empty the line | X |
| 5 | — | — |

With these details, the drinking water extraction unit now knows which types of water are available and can accordingly adapt its operating menu.

After some time, a water functional unit of a second, subsequent product generation (V2) comes onto the market, in which the carbon dioxide content can be adjusted, for example. On the other hand, a valve has been omitted and filtered water can no longer be provided. The feature list is then as follows:

| | | Supported by water |
|---|---|---|
| Feature no. | Description | functional unit V2 |
| 1 | Can provide filtered | — |
| | water | |
| 2 | Can provide chilled | X |
| | water | |
| 3 | Can provide carbonated | X |
| | water | |
| 4 | Can empty the line | X |
| 5 | Can provide carbonated | X |
| | water with an adjustable | |
| | CO2 content | |
| 6 | — | — |

There are now two conceivable scenarios:

a) The water functional unit V2 is used in a network in which it replaces a water functional unit V1. This network contains a drinking water extraction unit, the firmware of which was developed before the water functional unit V2 was developed. Therefore, the firmware of this drinking water extraction unit does not know what function is behind feature 5 of the water functional unit and simply ignores it. This drinking water extraction unit determines that this water functional unit can provide only chilled and carbonated water and no longer provides the user with the menu item for filtered water.

b) The water functional unit V2 is operated with a drinking water extraction unit, the firmware of which is aware of feature 5. The operating menu is accordingly adapted, with the result that the carbon dioxide content can be selected. If this drinking water extraction unit is operated with a water functional unit V1, the last-mentioned adjustment possibility is naturally not available since the water functional unit V1 cannot adjust the carbon dioxide content.

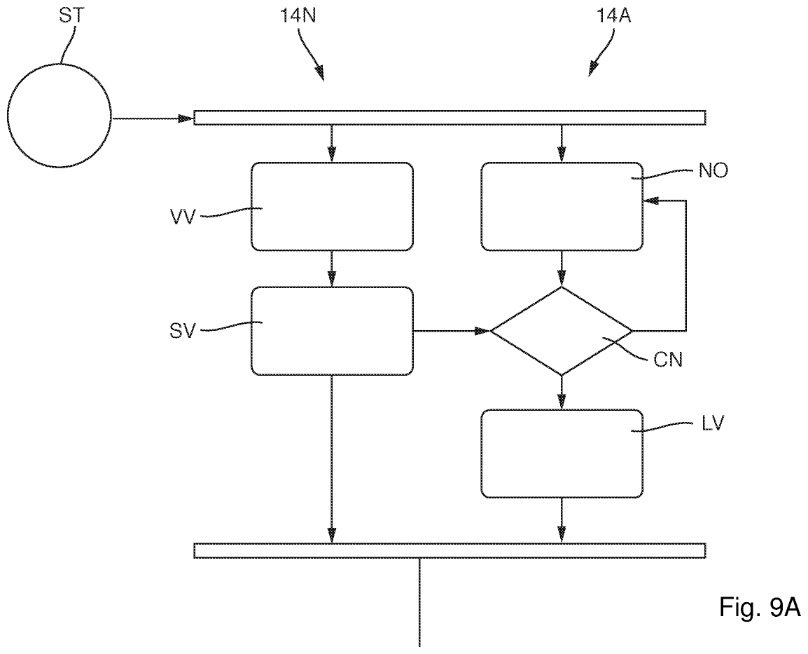

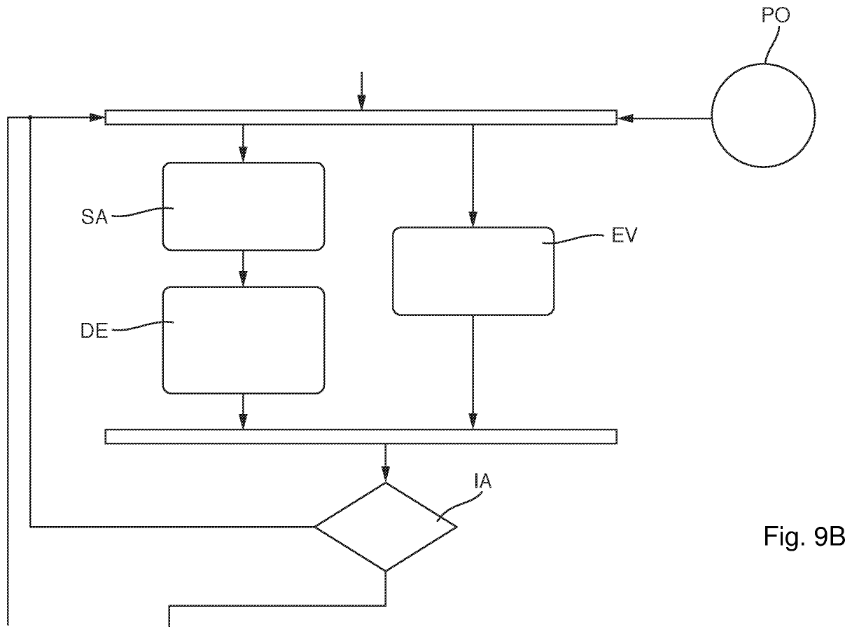

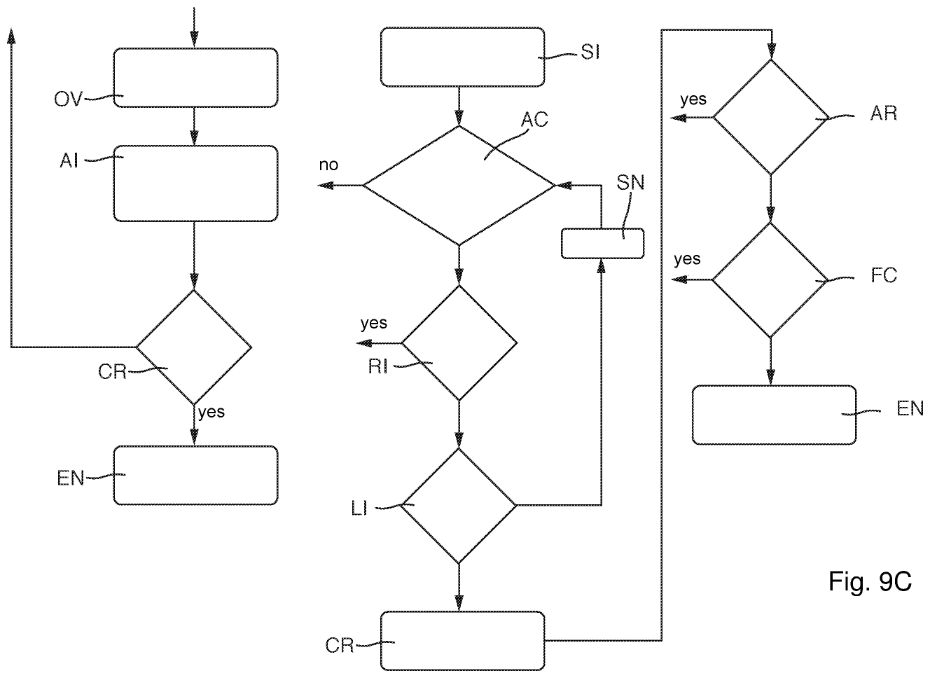

A distinction can be made between the following two scenarios when creating a device register, that is to say a table containing the “participants” available in the network: In the first case, devices are already running in the network and a new device is added. This can be carried out either on account of subsequent plugging into the bus or by subsequently supplying the device with energy. In the second case, all devices in the network are switched on at the same time. Case 1 is converted into case 2 by carrying out a reset on all devices in the network by virtue of each device deleting its old device register, for example, as soon as a new device in the network is detected. The sequence of creating a new device register is explained below using FIGS. 9A to 9C.

FIGS. 9A to 9C show a detailed flowchart which schematically illustrates the generation of a new device register R. In FIG. 9A, a new device 14N is connected to the network 12 at the start ST of the method for generating a new device register R. This is illustrated by the left-hand sequence path in FIG. 9A. The right-hand sequence path symbolizes an already existing device 14A in the network 12. Connection VV of the new device 14N causes the new device 14A to transmit SV a physical address A which may be a serial number of the device 14A, for example. In parallel with this, the existing device 14A has a normal operating state NO as long as it is not initiated to delete LV its device register R by the transmission SV. For this purpose, the existing device 14A has a checking entity CN which leaves the normal operating state NO provided that the initiation for deletion LV has not been effected by the transmission SV. If, however, a new device 14N is detected on the basis of the transmitted physical address A, the existing device register R is removed by deletion LV.

In the subsequent section of the flowchart in FIG. 9B, a distinction is no longer made between the new device 14N and the existing device 14A. This state is also assumed by the network 12 or the devices 14 in the network 12 when the voltage supply PO is switched on again. The device registers R are preferably newly set up when the voltage supply PO is switched on. For this purpose, transmission SA of all physical addresses A of the devices 14 participating in the network 12 is initiated, wherein the physical addresses A may be serial numbers. So that all physical addresses A can be received, devices 14 with higher priority may implement a time delay DE of a particular number of milliseconds. This ensures that low-priority physical addresses A are also stored. The physical addresses A are entered EV into the device registers R at the same time and until all physical addresses A have been entered into the device registers R. The compilation of the new device registers R is aborted IA, for example, after a particular number of seconds after the last physical address A has been entered into the device registers R. The physical addresses A are entered FV into the device registers R as long as this abort condition has not been satisfied.

In FIG. 9C, the physical addresses A in the device registers R are sorted OV. Network identifications ID are then assigned AI according to the position of the physical addresses A in the device registers R after sorting OV. The correctness of the device registers R is checked by the devices 14 in a further checking entity CR. If an error is determined by the checking entity CR in a device register R, the transmission SA of all physical addresses A of the devices 14 participating in the network 12 from FIG. 9B is repeated. However, if an error is not detected, the compilation of the device registers R is completed. After completion EN, the devices 14 return to the normal operating state NO.

For checking by the checking entity CR, transmission SI of the physical address A or of the network identification ID to all devices 14 is initiated. In all devices 14, the device registers R are compared AC with the received physical addresses A or network identifications ID. In this case, an error can be detected, and transmission SA of all physical addresses A of the devices 14 participating in the network 12 from FIG. 9B can be repeated. If an error is not yet detected in the comparison AC, a check RI is carried out in order to determine whether another device 14 with the same physical address A or network identification ID is transmitting. If it is determined that a device 14 with the same physical address A or network identification ID is transmitting, transmission SA of all physical addresses A of the devices 14 participating in the network 12 from FIG. 9B is repeated. If no further device 14 with the same physical address A or network identification ID is transmitting, the last device LI in the device register R is then identified. The last device LI emits a completion signal FR for checking the device register R. If the last device LI has not been reached, a next physical address A or network identification ID from the device register R is transmitted SN. If, like the last device LI, the remaining devices 14 have now likewise completely and uniquely compiled their device registers R, the remaining devices 14 transmit a confirmation AR. If the confirmation AR is not transmitted by at least one device 14 since the respective device register R has not been completely and uniquely compiled, transmission SA of all physical addresses A of the devices 14 participating in the network 12 is repeated. A conclusive check FC in order to determine whether all devices 14 from the device register R have been checked is carried out before completing EN the writing to the device registers R. If not all devices 14 from the device register R have been checked, transmission SA of all physical addresses A of the devices 14 participating in the network 12 is repeated. After completion EN, the devices 14 return to the normal operating state NO.

After the explained sequence, according to which the device register is sorted and checked, each device transmits its feature list. All devices store the feature list in their device register.

### LIST OF REFERENCE SIGNS

A Address

AC Comparison of physical addresses or network identifications

AI Assignment

AR Confirmation

CN Checking entity

CR Checking entity

DE Time delay

E Creation of the menu

EN Completion

EV Creation of a new device register

F Function

FC Conclusive check

FR Completion signal

IA Abort

ID Network identification

LI Last device

LV Deletion of the device registers

M Control menu

NO Normal operating state

OV Sorting of the entries in the device register

P Control menu item

PO Switching-on of the voltage supply

R Device register

RI Check

SA Transmission of physical addresses of all devices

SI Transmission of physical addresses or network identifications

ST Start

SV Transmission of the physical address of a new device

VV Connection of a new device

8 Data connection

9 Hydraulic connection

10 Extraction unit

11 Drinking water

12 Network

13 Controller

14 Device

140 Coffee machine

141 Loudspeaker

142 Valve

143 Light

145 Dishwasher

146 Energy measuring device

14N New device

14A Old device

15 Water functional unit

151 First water functional unit

152 Second water functional unit

16 Display

17 Command input element

18 Display means

19 Rotary pushbutton

20 Voice assistant

22 Capacitive sensor

24 External sensor

26 Central controller

28 Mobile terminal

30 Radio connection

1. A method for adapting a control menu (M) of a controller (13) of an extraction unit (10) for drinking water (11) having a command input element (17) for selecting a control menu item (P) of the control menu (M), the extraction unit being adapted to communicate with one or more devices to form a network (12), the method comprising:
connecting (VV) a new device (14) to the network (12),
automatically transmitting (SV) a physical address (A) of the new device (14) to the extraction unit (10) via the network (12), automatically creating (EV) a new device register (R) with the physical address (A) of the new device (14) in the controller (13) of the extraction unit (10), and
automatically adapting the control menu (M) of the extraction unit (10) to the new device register (R), such that the new device (14) is controllable via the command input element (17).

2. The method as claimed in claim 1, further comprising automatically creating the control menu item (P) in the control menu (M) that represents the new device (14) in the extraction unit (10).

3. The method as claimed in claim 1, further comprising automatically blocking the extraction unit (10) by the control menu (M) upon the controller (13) of the extraction unit (10) detecting a conflict between two of the devices (14) in the network (12).

4. The method as claimed in claim 1, further comprising deleting a control menu item (P) in the control menu (M) upon a device (14) being removed from the network (12).

5. The method as claimed in claim 1, further comprising deleting (LV) an old device register (R) upon the controller (13) of the extraction unit (10) having received the physical address (A) of the new device (14).

6. The method as claimed in claim 1, further comprising sorting (OV) the device register (R) based on properties of the physical addresses (A) of the devices (14) and an indication of the respective physical address (A) with a network identification (ID).

7. The method as claimed in claim 6, further comprising checking (PV) whether the network identification (ID) is uniquely assigned to one said physical address (A) and repeatedly transmitting the physical addresses (A) in case of an incorrect assignment.

8. The method as claimed in claim 1, further comprising the new device (14), after transmitting (SV) the physical address (A), transmitting a list containing supported functions, and the controller (13) of the extraction unit (10) storing the functions supported by the new device (14) in the device register.

9. The method as claimed in claim 1, further comprising identifying a function (F) of the device (14) based on the device register (R) and creating the function (F) as a control menu item (M), wherein the device (14) comprises a water functional unit (15).

10. The method as claimed in claim 1, further comprising displaying at least one of a control menu item (M) of the device (14), a function (F), or blocking of the extraction unit (10) on a display (16) of the extraction unit (10), and activating different display elements (18) for different control menu items (P).

11. The method as claimed in claim 1, further comprising mutually coordinating a plurality of said devices (14) which are connected to the extraction unit (10) and, according to stored functions (F) associated with the control menu items (P), treat drinking water (10) which can be removed from the extraction unit (10) with regard to at least one of a temperature, carbon dioxide content, or degree of filtering.

12. The method as claimed in claim 1, further comprising starting dispensing of drinking water (11) from the extraction unit (10) by a voice command.

13. The method as claimed in claim 1, further comprising starting dispensing of drinking water (11) by touching (B) the extraction unit (10), using a capacitive sensor (22) for detecting a touch or by actuating (B) an external sensor (24).

14. The method as claimed in claim 1, wherein the controller (13) of the extraction unit (10) is connected to the network via at least one of a radio connection or a wired connection.

15. An extraction unit (10) for drinking water (11), comprising:
a controller (13) with a control menu (M) having control menu items (P),
a command input element (17) configured to select at least one said control menu item (P),
an interface configured for connection to a network (12),
the controller (13) being configured to automatically detect a new device (14) in the network (12) and to automatically receive a physical address (A) of the new device (14) via the network (12) and to generate a new device register (R) having the physical address (A) of the new device (14) in the controller (13) of the extraction unit (10) and to adapt the control menu (M) to the new device register (R), such that the new device (14) is controllable via the command input element (17).

16. The extraction unit of claim 15, wherein command input element (17) comprises a rotary pushbutton (19).

17. The method of claim 10, wherein the display elements comprise light-emitting diodes with different colors.

18. The method of claim 13, wherein the external sensor (24) is a foot switch.
